(19) United States
(12) Patent Application Publication
(10) Pub. No.: US 2016/0246898 A1
(43) Pub. Date: Aug. 25, 2016

(54) 3dT FRAME MODELING APPARATUS

(71) Applicant: Managing Innovation and Technology, Inc., Irving, TX (US)

(72) Inventors: Ted J. Roepsch, Irving, TX (US); George A. Deprez, Irving, TX (US); James A. Holbrook, Irving, TX (US); Jorge Bermeo Hernandez, Irving, TX (US); Gregory J. Peterson, Irving, TX (US); Brian A. Mauldin, Irving, TX (US); Omar F. Aragon, Irving, TX (US); Jeremy E. Tinker, Irving, TX (US); Hollie I. King, Irving, TX (US); Qiang Li, Irving, TX (US); Keith Smet, Irving, TX (US)

(21) Appl. No.: 14/631,535

(22) Filed: Feb. 25, 2015

(51) Int. Cl. G06F 17/50

(52) U.S. Cl. CPC G06F 17/50

(57) ABSTRACT

An invention uses three-dimension frame scanning to create a 3D model of the lens openings so that a finished lens cut data file can be created by a noncontact mapping of the frame in which the lens will be installed by a noncontact method combination of articulation and sensor measurements.

### TECHNICAL FIELD OF THE INVENTION

An invention that provides eye frame scanning to create a 3D model of the lens openings so that a finished lens cut data file can be created with precision of less than 300 microns by a noncontact method combination of articulation and sensor measurements.

### BACKGROUND OF THE INVENTION

Existing techniques to measure eyeglass frame dimensions employ a mechanical stylus. See, for example, US20140020254, US20130067754, and U.S. Pat. No. 8,578,617, which all describe mechanical contact methods to measure the shape and dimensions of the frame needed to fit the glass. These patents describe measuring the groove of the frame to get information about the shape and dimensions of the frame which assists an eyeglass maker to decide on the dimensions to cut a lens and its bevel to fit a frame.

There are a number of problems that remain in the prior art.

Measurements with a stylus in the tracer machine at a optician's office location result in errors in the lens cut at a lab which has the cut/edger machine due to calibration errors between the different instruments. The mechanical instrument needs to be calibrated often in the optician's office to ensure accurate measurements.

The tracer stylus often falls out of the groove and fails to accurately measure the depth due to groove width or sharp curving turns around the frame corner. The resulting lens may end up with gaps between the frame and the lens in corners.

Frame shapes can be easily distorted, especially thin plastic frames, because the lenses (dummy or actually used) are removed for enabling stylus-based measurement.

Frame bending can occur as a result of bevel incorrectly positioned on the lens edge. This results in the frame user feeling that the frame does not look like what he expected while trying on the frame with dummy lenses.

Additional time and shipping charges result from the need to ship frames to the remote lab for tracing, cutting, edging and fitting of the lens to the selected frame. Any delay can impact frame scheduling, sometimes for multiple opticians, piling up in the labs for measurement and processing.

### SUMMARY OF THE INVENTION

The invention is an apparatus which uses an automated process to examine and map the contour of the grooves in a set of eyeglasses, providing the data to a lens-cutting device for fast turn-around and more precise and accurate lens fitting.

### BRIEF DESCRIPTION OF THE DRAWINGS

FIG. 1 is an orthogonal view of one embodiment of the apparatus.

FIG. 2 is a side view of the embodiment of FIG. 1.

FIG. 3 is an example of a Scan Platform Stage.

FIG. 4 is a front view of the invention as in FIG. 1.

FIG. 5 is a top view of the invention as in FIG. 1.

FIG. 6 is a flow chart of the operation of one embodiment of the invention.

FIG. 7A is a front view of the region of interest showing standard scanning method.

FIG. 7B is a front view of the region of interest showing an optional scanning method.

FIGS. 8A, 8B, and 8C shows a side view, a bottom view and a rear view of one embodiment of the Diverter 35.

FIG. 9A shows one possible embodiment of a Diverter Mount 39 (without the Diverter 35).

FIG. 9B shows the embodiment of the Diverter Mount 39 while holding the Diverter 35.

### DETAILED DESCRIPTION OF THE INVENTION

As shown in the drawings, an eyeglass Frame 11 is positioned in a horizontal orientation upside-down on a Scanning Platform 21 with the temples facing the user at the front of the invention. The Frame's bridge is aligned to an Index Key 23. The Frame 11 is typically oriented with its top facing down to maximize its stability while it is being processed.

The invention operates in two stages, a Front Frame Scan stage and a Groove Scan stage. The Front Frame Scan stage creates a mapping of the front view of the Frame 11. This is accomplished by using a Sensor 25 that is moved along the horizontal (x-axis, running generally parallel to the plane of the frame lenses) and vertical (z-axis) space in front of the frames. This scan can optionally track the wrap of the Frame by determining its change in depth from the frontmost portion of the Frame, located at the Index Key 23.

The Sensor 25 sends data to a CPU 31 which is programmed to accept the information and create a multi-dimensional Frame Map 41 of a front view of the frame.

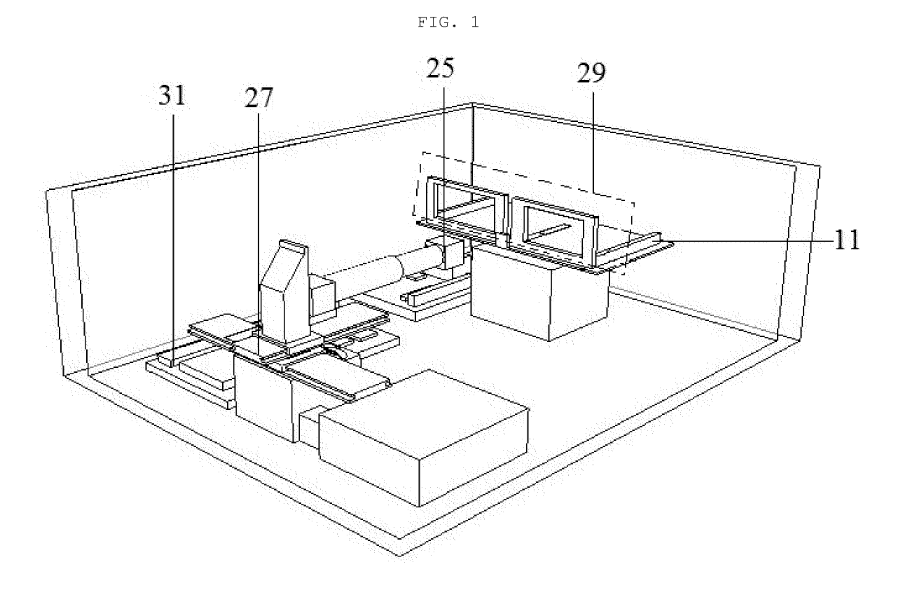

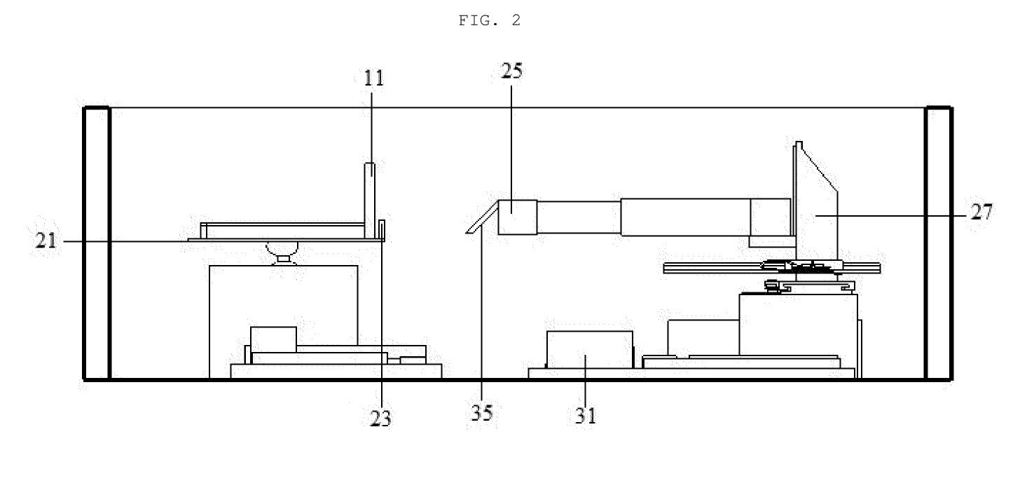

As shown in FIG. 1, the current embodiment uses a camera as the Sensor 25. In this embodiment, the Sensor 25 is moved using a three-dimensional motorized xyz linear translation Stage 27. The entire area in which the Sensor can be moved in the x-z plane is the Region of Interest 29, the boundary of which is indicated by a dotted line.

Though a custom three-dimensional Stage 27 can be constructed, the industry more commonly uses commercially available x-y two-stage platform with the addition of an z-axis lift stage. There are many such constructions that are available commercially that can position the Sensor 25 in front of the Frame 11 and move the camera over the Region of Interest 29, as this rectangular area envelopes the potential front view of a conventional Frame 11.

The CPU 31 directs the Stage 27 to move the Sensor 25 which begins at one corner of the Region of Interest 29, takes a picture of the space directly in front of the camera, is moved in small steps along one axis until it reaches the far side of its motion, then moves perpendicular in one step, and travels back the other way, so that the until the Region of Interest 50 is covered, and the Sensor 21 input is fed to the CPU 31, which can then use industry available techniques to convert the Sensor's input to a single image Frame Map 41 of the Region of Interest 50 and the Frame 11 within it.

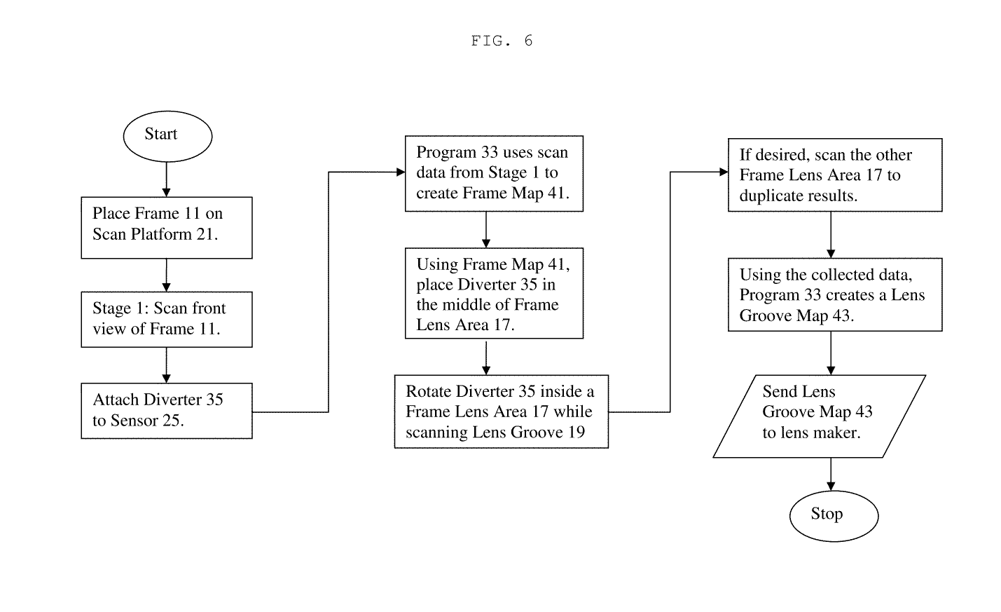

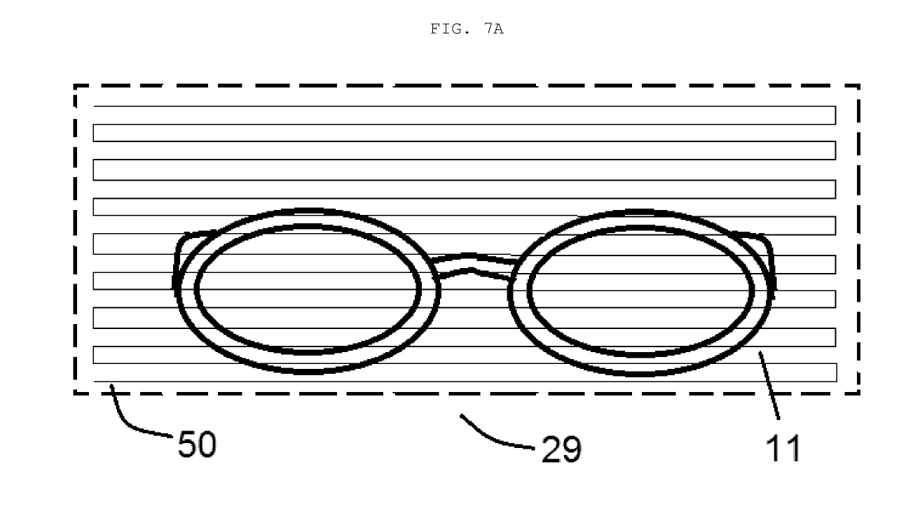

FIG. 7A demonstrates one potential Scan Path 50 for the Sensor 25 as it travels through the Region of Interest 29. This path makes no assumption regarding symmetry of the Frame 11, or centralized position.

To more quickly create the Frame Map 41, an assumption can be made during the scan process that the Frame 11 is symmetrical along the y-axis. Using that assumption and building up the Map 51 during the scan process, the time necessary to build up a Map 51 can be almost halved by keeping track of where the Frame 11 appears in the Map 51, and then after scanning that entire x-axis, calculating the exact middle of the Frame 11 in the x-axis by averaging the mapping of the Frame 11 at its far sides (typically at the temples). The calculation can be conducted for more than one row of scanning, and repeating the calculation for each row.

Employing the symmetrical assumption approach explained above, FIG. 7B shows one potential Optimized Scan Path 51 for the Sensor 25. This path first takes the Sensor 25 across the middle of the Region of Interest 29 to establish the extent of the Frame 11, so the Program 33 can calculate the location of the middle of the Frame 11, and then merely scan one half of the Region of Interest, and using the scanned information from the left half of the Region of Interest, the Program can create a Frame Map 41.

To further ensure that the invention has calculated the middle of the Frame 11, the Program 33 can repeat the calculation or add scan paths across the entirety of the Region of Interest 29, until the margin of error is acceptable.

In the current embodiment, the Program 33 starts the scan at the lower left, and then sends input to the CPU, which uses that input to detect the presence of the Frame 11 directly in front of the Sensor 25. As the invention completes the first three rows of scans, the CPU can use the data of the first three rows to determine the middle.

By taking three calculations, the Program 33 first determines whether it received helpful data by comparing the middle calculation of each row. If one row is dramatically different from the others, for example, if the CPU calculates that the Frame 11 is 5.5″ wide, but the CPU determines from the input from the third scan calculates and finds a 6.5″ wide Frame 11, clearly one of the sensor readings is in error. The Program 33 discards the data from the third scan, and conducts an additional full line scan on additional lines until the Program determines that it has sufficient information to be sure that the correct location of the middle of the Frame 11 is known to the degree desired, or that it is malfunctioning and reports an error to the user. The allowable variation between the calculations can vary with a user setting, but in the current embodiment, the Program 33 will find a difference of more than one millimeter to be unacceptable.

Given the extent of the Frame 11 from the calculations of the Program 33 and its middle, the invention determines how inaccurate the Frame 11 placement is, and calculates where the Frame 11 is sitting in relation to the Index Key 23.

The invention can scan the entire Region of Interest 50 and ensure that any non-symmetrical elements of the Frame 11 is noted, as shown in FIG. 7A. Alternatively, the invention could employ a more efficient scan by first scanning horizontally along the middle of the Region of Interest 50, and establishing the middle of the Frame 11 by determining where the images show the extent of the Frame 11, and then taking advantage of the symmetry of the Frame.

FIG. 7B demonstrates the efficient approach, showing the full length scan paths. The Stage 27 can move the Sensor 25 along only one side of the Region of Interest 50, feeding that information to the Program 33, which then creates the Frame Map 41 from the scanned side of the Frame 11, and then uses the known data to complete the Frame Map 51.

The Control System 31 can validate the Map 51 built using the above scheme by moving to the location where the second side of the Frame 11 should end on one or more initially unscanned ends of rows, based on the assumption that the Frame 11 is symmetrical and the Sensor-collected data can be used by the Program 33 to complete the Frame Map 41 from the area already scanned.

In this validation process, the Frame Map 41 can account for a miscentered Frame 11 by traveling the width of the Frame and assuming it is symmetrical, and thereby detect the amount by which it is not centered, and then adjust the mapping. For example, assuming that the Index Key 23 middle of the camera-scannable area is given the point (0,0), the Program 33 determines that the extent of the Frame 11 is (−3.0″, 0″) to (2.5,0), concluding that the Frame is 5.5″ wide from temple to temple, and that the Frame 11 is positioned 0.25″ to the left. The Program 33 uses that information to tell the Stage 27 to move the Sensor 25 so it starts on the left side of the Frame 11, travels along the Frame 11 until it has scanned past the frame middle (physically identified as the middle of the Bridge 15), and then travels back to the left side again.

As the Program 33 receives data from the Sensor 25, the Program creates the Frame Map 41 using the left-side data to draw the right side of the Frame 11.

In the Groove Scan Stage, a Sensor 25 (usually a camera) is centered in the middle of a Frame Lens Area 17 by the Stage 27. Instead of using a Sensor 25 to map the front view of the Frame 11, the Sensor will now create a frame Lens Groove Map 43. It is that Lens Groove Map 43 that is provided to a lens maker in order to cut the lenses to fit the Frame 11.

To obtain the necessary data, the Program first uses the Frame Map 43 to determine the middle of each Frame Lens Area 17 using industry-known techniques. It is not critical that the exact middle of the Frame Lens Area 17 is located; the salient issue is to locate a position in the Frame Lens Area 17 in which the Sensor 25 can be placed so it can rotate and easily scan the Lens Groove 19 from roughly in the middle of the Lens Area 17.

To construct the Lens Groove Map 43, the Program collects image information from the Sensor 25 as it rotates within the Frame Lens Area 17. In the current embodiment, the Sensor 25 used in this stage is a camera as discussed in stage one, with a Diverter 35 that turns the Sensor angle of operation by 90° so the camera serving as the Sensor 25 can scan images of the Lens Groove 19.

In the current embodiment, the Diverter 35 is a mirror that sits at the end of the camera that serves as the Sensor 25 and is directed along the y-axis, held in an extended position by a Rotational Element 37 that operates to correctly turn the Sensor 25 (camera) during the Groove Scan Stage of the invention's operation.

The Diverter 35 only operates during the Groove Scan stage of the invention's operation. A user can be prompted by the invention after the Front Frame Scan Stage to place the Diverter 35 on the end of the Sensor 25. Alternatively, the Diverter 35 can be kept on a Diverter Mount 39. Upon beginning the Groove Scan stage, the invention moves the Sensor 25 to engage the Diverter, which can be affixed on the Sensor by a friction hold, a snap-in connection, or other means for holding the Diverter 35 on the end of the Sensor 25.

When the Groove Scan Stage is completed, the Diverter 35 must be removed prior to performing a Front Frame Scan. This removal can be by hand or an automated process in which the invention's Program 33 instructs the Sensor 25 to move so that the Diverter 35 is placed back on the Diverter Mount 39.

There are many methods of holding the Diverter 35 on the Mount 39 that are known in the art, including the use of a simple lip on the Mount 39. To install the Diverter 35, the invention pushes the Sensor 25 onto a Diverter 35, and then lifts it off of the Mount 39, so the Diverter 35 does not catch the lip of the Mount 39.

To uninstall the Diverter 35 from the Sensor, the Program 33 moves the Sensor to place the Diverter 35 on the Mount 39, and then use the lip on the Mount 39 so the Mount 39 catches the edge of the Diverter 35 and dislodges it so it remains on the Mount as the Sensor 25 moves from the Mount 39.

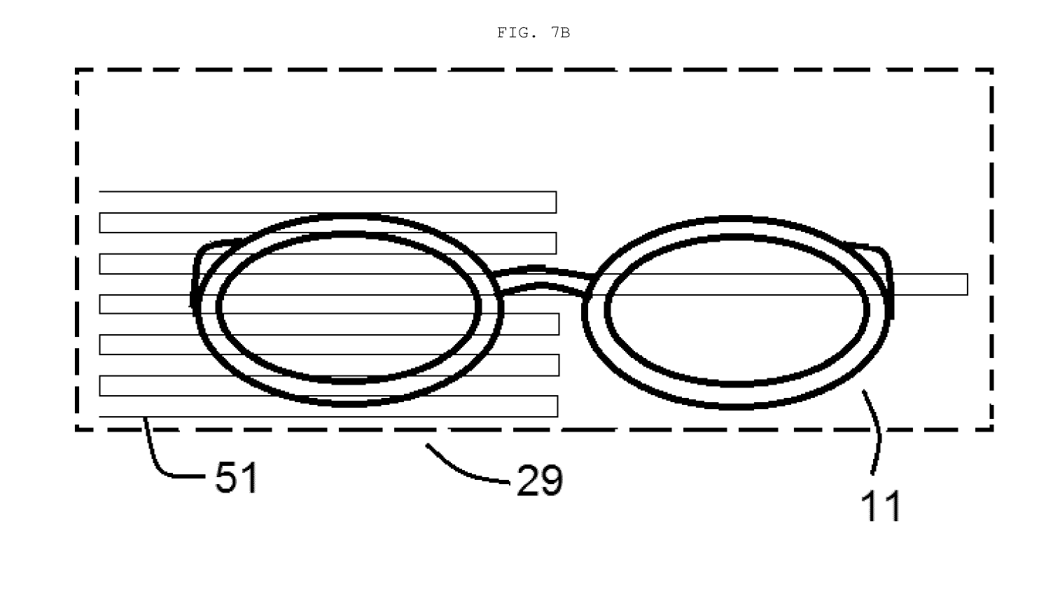

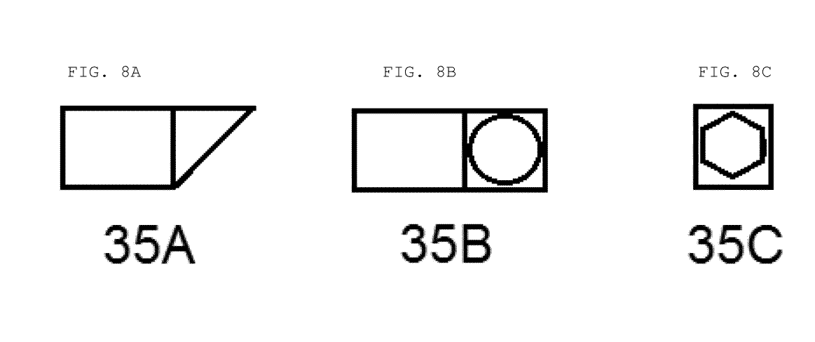

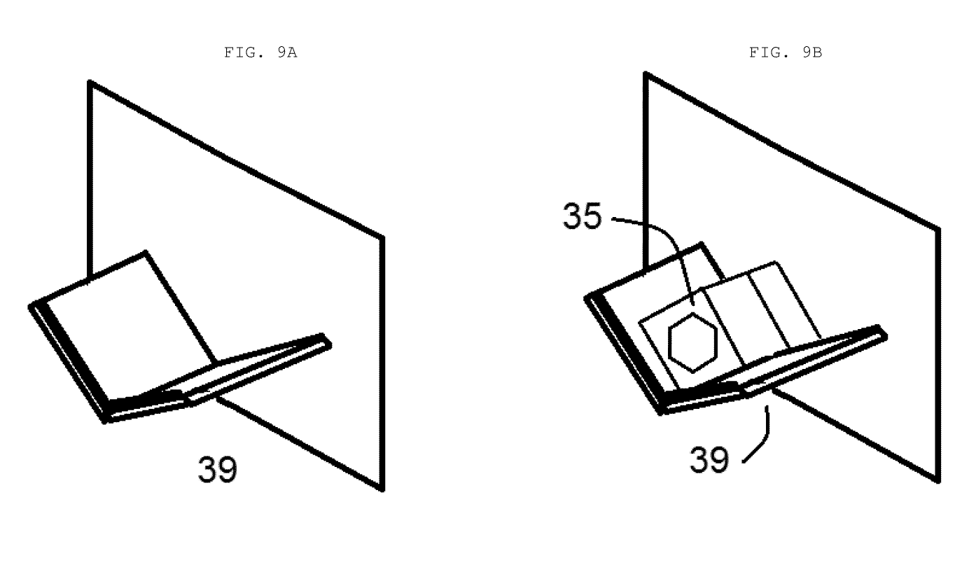

An example of one possible construction of the Diverter 35 is shown in FIGS. 8A, 8B and 8C. An example of one possible embodiment of a Diverter Mount 39 without the Diverter 35 is shown in FIG. 9A. One embodiment of a Diverter Mount 39 while holding Diverter 35 is shown in FIG. 9B.

To control the Sensor 25 so it tracks the Lens Groove 19, the three-dimensional Stage 27 is supplemented with up to three extra degrees of controlled movement—rotate, yaw, and pitch (r-y-p), constructed with commercially available motion control stages.

The rotation of the Sensor 25 is required to collect images from the Lens Groove 19. To track the wrap of the Frame 11, the “yaw” must correct for the Frame wrap while the scan is in process and make adjustments during the scan to maximize the accuracy of the mapping of the Lens Groove 19.

To ease this difficult process, the first stage of the operation can track the bend of the Frame 11 during its scans while the invention develops the Frame Map 41. Using the depth of the Frame 11 as it is intended to wrap around a user's head, the invention can turn the direction of the Sensor 25 so it is continuously perpendicular to the part of the Lens Groove 19 that the Sensor is facing as it rotates.

The Sensor 25 again sends data to the Program 33, which compiles the data and creates the Lens Groove Map. This data is compiled and used to model the fit of the lens so that a lens-cutting device can cut the lens without error.

The Region of Interest 29 is the rectangular maximum area in both length and width which envelopes the Frame outline and defined by the extent of the Sensor 25 movement.

This disclosure thus far includes a possibility of a six-axis (xyz-rpy) articulation to be used to position the Sensor 25 within a eye frame lens opening. The Region of Interest 29 for scanning will be the Lens Groove 19 that the lens is seated in such that the width and depth of the Grove 19 may be used to create the Lens Groove Map 43.

The width of the scan is determined by the size of the field of view of the Sensor 25. The number of passes that the Sensor 25 requires to cover the Region of Interest 50 is based on the size of the field of view, as a Sensor 25 (a miniature camera in the current embodiment) with a small field of view will require more scans than a Sensor 25 with a wider field of view.

For purposes of this embodiment of the invention, the x-axis is parallel to the frame length, the y-axis is the depth of the Frame 11 (starting at the Bridge 15 and going straight, and the z-axis is used to indicate elevation from the Scanning Platform 21.

In the embodiment shown in the figures, the invention may be constructed to change the pitch (p) and yaw (y) of the Scanning Platform 21 to align the Sensor 25 and Lens Groove 19 with an optimal scanning position.

During the Groove Scan Stage of the invention use, the Sensor 25 is operated so it gathers images from the Lens Groove 19 by rotating the Sensor 25 around an axis as it is positioned to analyze the Lens Groove 19 in 360 degrees from a fixed position (specified in terms of xyz or xyz-py).

Additional transposition movements in (xyz or xyz-py) may be utilized to best utilize the measurement range of the sensor during a rotation and scan procedure.

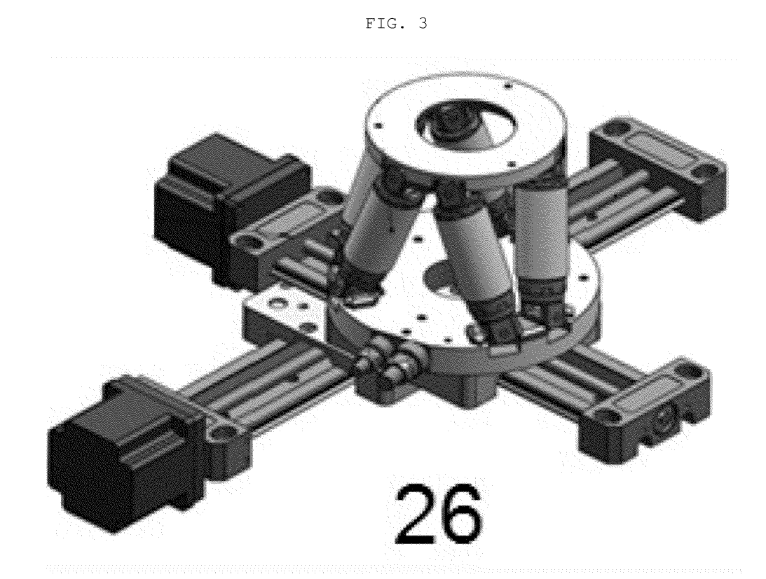

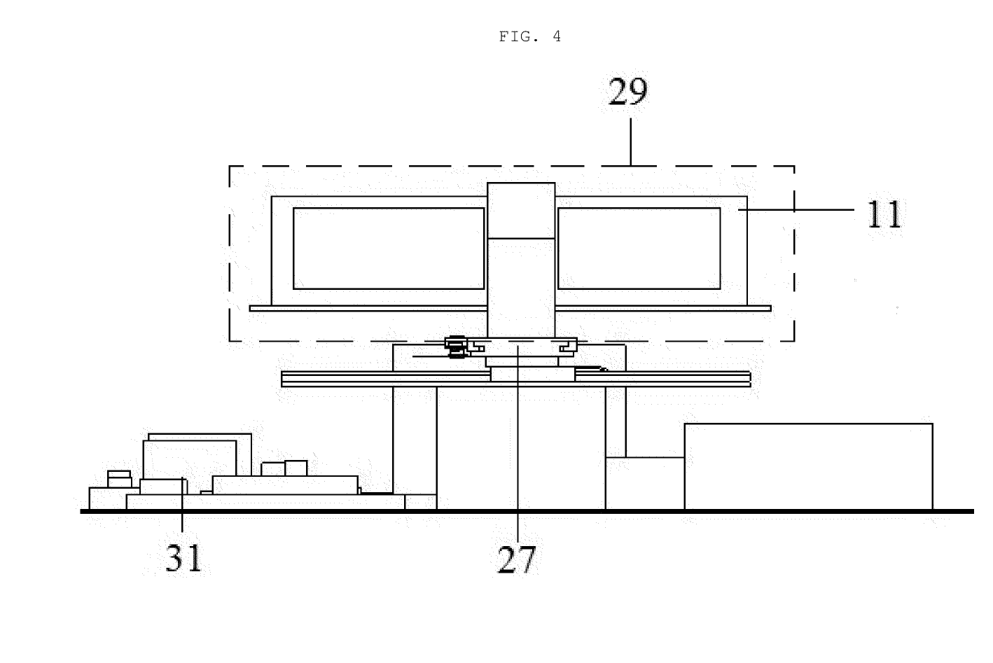

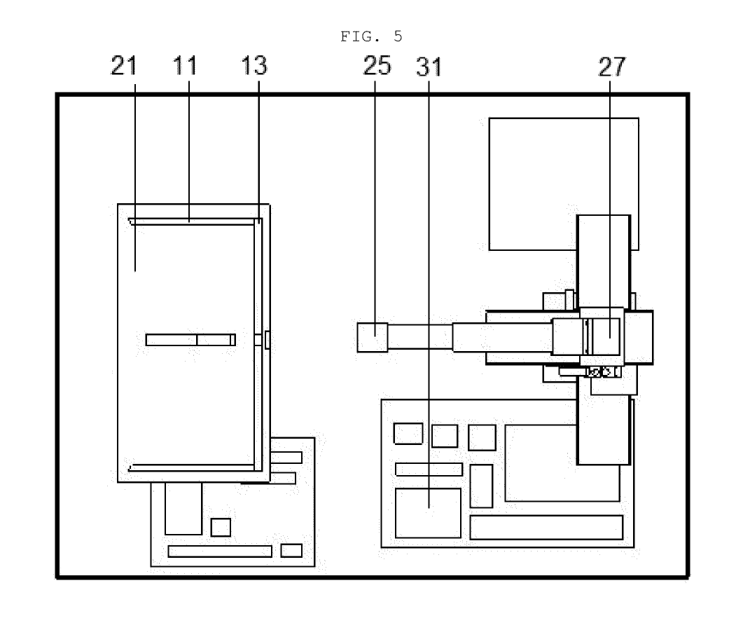

The drawings show the Scanning Platform 21 as either a non-moving element, or an element with limited pitch and yaw motion. However, the invention can be completely operated with the xyz and pitch positioning provided by the Scanning Platform 21 that is constructed with an appropriate multi-dimension Scan Platform Stage 26 such as shown in FIG. 3.

The invention is not limited by the disclosed construction; it is known in the art to use motion control stages to move the Sensor 25 or the Scanning Platform 21 so that the spatial relationship between the Frame 11 and the Sensor 25 is maintained and image data properly collected. Therefore the invention is not limited to the x-, y-, and z-axis motion to the Sensor 25 apparatus, and the pitch and yaw to the Scanning Platform 21—all five directions of motion could be handled by the Scanning Platform 21 and the Sensor 25 merely handle the rotation aspect.

Though the embodiment uses a camera for the Sensor 25 element capable of creating data mapping of the Lens Groove 19 to 300 microns, the invention is not limited to the use of a camera; a laser/sensor combination can be employed to detect distance and create the necessary images.

Similarly, the invention is not limited to the embodiment disclosed in any other aspect. For example, the Diverter 35 can employ a threaded mount onto the Sensor 25, or some sort of quarter-turn lock, or any number of methods well-known in the industry.

Legend:

11 Frame
15 Bridge
17 Frame Lens Area
19 Lens Groove
21 Scanning Platform
23 Index Key
25 Sensor
27 Stage (Sensor)
28 Scan Platform Stage
29 Region of Interest
31 CPU
33 Program
35 Diverter
37 Rotational Element
39 Diverter Mount
41 Frame Map
43 Lens Groove Map
50 Scan Path
51 Optimized Scan Path

The inventors claim:

1. An apparatus for creating a model of an eyeglass frame opening, comprising:
a. a scanning platform;
b. an index key;
c. a sensor capable of determining distance or capturing images,
d. one or more motion control stages
e. a computing device
f. software to operate the computing device.

2. An apparatus as in claim 1, in which the sensor is equipped with motion control to position and rotate the sensor.

3. An apparatus as in claim 2, in which a diverter is available which a user can employ on the sensor so that it captures images which are at a 90-degree angle from the axis of rotation.

4. An apparatus as in claim 1, in which the software can instruct the motion control stages to position a pair of eyeglass frames on the scanning platform while the sensor captures distance or capturing images, and use those images to create a map of the frame.

5. An apparatus as in claim 1, where the sensor is a camera.

6. An apparatus as in claim 2, where the sensor is a camera.

7. An apparatus as in claim 6, in which the camera and motion control system has sufficient accuracy that a finished lens can be cut with precision of less than 300 microns.

8. A method of creating a three-dimensional model of the lens opening, comprising.
a. Placing eye glass frames upside down in a horizontal orientation on a scanning platform with the temples facing the operator;
b. Aligning the eye glass frames to an index key;
c. Beginning at a home position, articulating a sensor across a region of interest in which a pair of eye glass frames sits, positioned with its temples downward;
d. Recording scanned images across the region of interest, adjusting the distance between the frame and the camera for maximum precision and a sufficient number of images to create a map of the front of the eyeglass frames.

9. The method of claim 8, further including the step of: articulating the scanning procedure the sensor package may be articulated along an x-axis to sweep the length of the frame, along the y axis to sweep the height of the frame and along the z-axis to sweep the wrap of the frame.

10. The method of claim 8, further including the step of: manipulating the scanning platform in up to two axis (py) to align the groove with an optimal scanning position.

11. The method of claim 8, further including: rotating the sensor during a groove scan of the frame to analyze the groove in 360 degrees from a fixed position (xyz) or (xyz-py).

12. The method of claim 8, further employing online projection triangulation analysis to generate and handle capturing calculations as they are made across the projected line so that multiple distance data points can be calculated with one image capture.

13. The method of claim 8, further storing cross-sectional profiles on a device which can subsequently process the data into relevant measured points in 3D space.

14. The method of claim 8, in which the scan of the region of interest in step ‘d’ is made more efficient by reducing the horizontal scans of the sensor so that the data collected on one side of the scan, i.e., one lens area and the bridge of the eyeglass frame, is used to produce the data representing a non-scanned side of the frame by using the scanned side and an assumption that the frame is symmetrical, and a limited number of scans extending across the entire region of interest.
